(19) United States
(12) Patent Application Publication
(10) Pub. No.: US 2024/0383548 A1
(43) Pub. Date: Nov. 21, 2024

(54) WHEEL ASSEMBLY, TRACK SYSTEM AND VEHICLE WITH SAME

(71) Applicant: SOUCY INTERNATIONAL INC., Drummondville (CA)

(72) Inventor: Jeremie AUBIN-MARCHAND, St-Hugues (CA)

(21) Appl. No.: 18/668,011

(22) Filed: May 17, 2024

Related U.S. Application Data
(60) Provisional application No. 63/467,619, filed on May 19, 2023.

(51) Int. Cl. B62D 55/14; B62D 55/10; B62D 55/104

(52) U.S. Cl. CPC B62D 55/14; B62D 55/10; B62D 55/104

(57) ABSTRACT

A tandem wheel assembly, which is for a track system, includes a wheel-carrying structure, a first wheel, a second wheel, a third wheel and a fourth wheel. The wheel-carrying structure pivotably connectable to a frame of the track system. The wheel-carrying structure is configured to pivot relative to the frame about a pivot axis. The wheel-carrying structure includes a first portion extending on one side of the wheel-carrying structure and a second portion extending on the other side of the wheel-carrying structure. The first and second wheels are rotationally connected to the first portion, the first wheel being longitudinally spaced by a first distance from the second wheel. The third and fourth wheels are rotationally connected to the second portion, the third wheel being longitudinally spaced by a second distance from the fourth wheel. The second distance is different from the first distance.

### CROSS-REFERENCE

The present application claims priority from a U.S. provisional application No. 63/467,619, filed on May 19, 2023, the content of which is incorporated herein by reference in its entirety.

### TECHNICAL FIELD

The present technology generally relates to wheel assemblies, track systems, vehicles having track systems, and track system configurations. More specifically, the present technology relates to tandem assemblies for track systems to minimize vibrations in the track systems.

### BACKGROUND

Certain off-road vehicles, such as all-terrain vehicles (ATVs and UTVs), may be equipped with track systems which enhance their traction and floatation on soft, slippery and/or irregular grounds (e.g., soil, mud, sand, ice, snow, etc.) on which they operate. Track systems typically provide a larger contact area (patch) on the ground thanks to an endless track compared to the size of the contact area (patch) of a wheel on the ground. Floatation over soft, slippery and/or irregular ground surfaces is increased, and the lower portion of the vehicle is maintained at a greater distance from the ground surface.

Track systems, due to the loads they bear and the conditions under which they are used, may require maintenance operations and can require replacement of some parts, such as support wheel assemblies, bushings, bearings, etc., These maintenance operations can be long, may occur frequently and can be expensive. Not performing these maintenance operations can reduce lifespan of other components of the track system. Furthermore, replacement of parts of the track can be expensive.

Track systems are subject to vibrations. U.S. Pat. No. 10,005,507, incorporated herein by reference in its entirety, discloses “tandem” assemblies for track systems where a pair of longitudinally spaced wheels can be collaboratively pivoting about a transversal axis. The function of a tandem assembly, in general, is to allow a pair of longitudinally spaced wheels to collaboratively pivot about a transversal axis. This provides, inter alia, better conformance to the ground (ride quality, traction, etc.) and to absorb at least a portion of the vibration induced by the obstacles the track systems travel on and/or a variation of stiffness of the endless track. Nevertheless, it has been observed that symmetrical tandem assemblies are not optimized for reducing vibrations.

Conventional tandem assemblies are “symmetrical” relative to a longitudinal plane of the tandem assembly. A symmetrical tandem assembly is said to be symmetrical in that a longitudinal distance between axles on a first side of the longitudinal center plane is generally equal to a distance between axles on the other side of the longitudinal center plane. Conventional symmetrical tandem assemblies typically contributes to reducing at least a portion of the vibrations but does not eliminate them completely. Thanks to the pivoting movement of the symmetrical tandems, the vibrations are reduced or divided but since both sides of the symmetrical tandem assembly are excited simultaneously when rolling on the inner surface of the endless track, vibrations are still present and detrimental to the comfort of the user and the integrity of the vehicle, track system or components of the track system.

In order to reduce the aforementioned drawbacks, there is a desire for a track system and parts thereof that can, inter alia, improve riding quality or comfort, reduce maintenance operations and/or enhance lifespan of various parts of the track system.

### SUMMARY

It is an object of the present technology to ameliorate at least some of the inconveniences present in the prior art.

In at least some embodiments of the present technology, developers have devised a tandem assembly that is “asymmetrical” relative to a longitudinal plane of the tandem assembly. It is contemplated that asymmetrical tandem assemblies may at least reduce vibrations in the track system. More specifically, some aspects of the present technology provide asymmetrical tandem assemblies that define a first and second portion having a first and a second longitudinal distance respectively, said first and second longitudinal distances being different such be the tandem assemblies are asymmetrical with respect to their longitudinal center plane.

As described in greater details herein after, the first longitudinal distance (denoted L₁ on FIG. 4B) may be higher than the second longitudinal distance denoted (denoted L₂ on FIG. 4B). In the context of the present disclosure, an asymmetrical assembly is said to be in a “long-side inside” configuration where a “short-side” (e.g. the second portion thereof when L₂ is smaller than the first portion) thereof is oriented toward an outer side of the corresponding frame and the “long side” thereof is oriented toward an inner side of the corresponding frame (i.e., towards the vehicle). An asymmetrical assembly is said to be in a “short-side inside” configuration where a “short-side” thereof is oriented toward the inner side of the corresponding frame and the “long side” thereof is oriented toward the outer side of the corresponding frame (i.e., away from the vehicle).

Some of the asymmetrical tandem assemblies disclosed herein are selectively and pivotably connected to a frame of a track system of the vehicle 10 such that orientation thereof may be selectively adjusted (e.g. from “long-side inside” configuration to the “short-side inside” configuration and vice versa). As described in greater details herein after, the asymmetrical tandem assemblies may be swappable and/or reversible.

In some other implementations, the asymmetrical tandem assemblies disclosed herein may be asymmetrical about a lateral center plane of a wheel-carrying structure thereof while being symmetrical about a longitudinal center plane (as tandem assembly 400).

Developers of the present technology have realized that using asymmetrical tandem assemblies can be used to as a suitable compromise between clearance with respect to the frame and reduction of vibrations. For example, one side of the asymmetrical tandem assembly may be better suited for one of increasing clearance and reducing vibration, while the other side of the asymmetrical tandem assembly may be better suited for the other one of increasing clearance and reducing vibration.

Developers of the present technology have realized that using asymmetrical tandem assemblies may be aid in increasing de-tracking resistance of the endless track. As a result, maintenance, repair and/or replacement of one or more components of the endless track may also be reduced.

Developers of the present technology have realized that using asymmetrical tandem assemblies may aid in reducing a turning radius of the vehicle by uneven load distribution on the endless track and/or ground surface. As a result, the maneuverability of a vehicle with track systems may be improved.

Developers of the present technology have realized that using asymmetrical tandem assemblies may aid in reducing steering effort and/or scrubbing effect by reducing torque required to steer due to smaller contact patch under scrubbing area.

It should be understood that some or all of the above-listed advantages may be present in some embodiments of the present technology.

According to one aspect of the present technology, there is provided a tandem wheel assembly for a track system. The tandem wheel assembly includes a wheel-carrying structure, a first wheel, a second wheel, a third wheel and a fourth wheel. The wheel-carrying structure is pivotably connectable to a frame of the track system, the wheel-carrying structure being configured to pivot relative to the frame about a pivot axis. The wheel-carrying structure includes a first portion extending on one side of the wheel-carrying structure and a second portion extending on the other side of the wheel-carrying structure. The first and second wheels are rotationally connected to the first portion, the first wheel being longitudinally spaced by a first distance from the second wheel. The third and fourth wheels are rotationally connected to the second portion, the third wheel being longitudinally spaced by a second distance from the fourth wheel. The second distance is different from the first distance.

In some embodiments, the tandem wheel assembly is selectively connectable to the frame of the track system.

In some embodiments, the tandem wheel assembly is connectable to the frame in one of a first orientation and a second orientation.

In some embodiments, in the first orientation, the first portion of the wheel-carrying structure is disposed on a first side of the frame, and in the second orientation, the second portion of the wheel-carrying structure is disposed on the first side of the frame.

In some embodiments, at least one of the first distance and the second distance is different from a pitch of traction lugs, and discrete multiples thereof, of an endless track of the track system.

In some embodiments, the wheel-carrying structure is symmetrical about a lateral center plane of the wheel-carrying structure.

In some embodiments, the wheel-carrying structure is asymmetrical about a lateral center plane of the wheel-carrying structure.

In some embodiments, the first distance is a sum of (i) a radius of the first wheel, (ii) a radius of the second wheel and (iii) a longitudinal clearance distance between the first wheel and the second wheel.

In some embodiments, the second distance is a sum of (i) a radius of the third wheel, (ii) a radius of the fourth wheel and (iii) a longitudinal clearance distance between the third wheel and the fourth wheel.

In some embodiments, the first portion comprises a first carrying-arm including a first axle onto which the first wheel is mounted, and a second axle onto which the second wheel is mounted. The second portion comprises a second carrying-arm including a third axle onto which the third wheel is mounted, and a fourth axle onto which the fourth wheel is mounted.

According to another aspect of the present technology, there is provided a track system including a frame, and one or more tandem wheel assembly of according to the above aspect or according to the above aspect and one or more of the above embodiments, each of the one or more tandem wheel assembly being pivotably connected to the frame.

In some embodiments, at least one of the one or more wheel assemblies is further removably connected to the frame.

In some embodiments, at least one of the one or more tandem wheel assembly is further connected to the frame in at least one of: a first configuration in which the at least one tandem wheel assembly is connected to the frame such that first and second wheel thereof are disposed inwardly from a longitudinal center plane of the track system and towards the vehicle, and a second configuration, in which the at least one tandem wheel assembly is connected to the frame such that first and second wheel thereof are disposed outwardly from a longitudinal center plane of the track system and away from the vehicle.

In some embodiments, the one or more tandem wheel assembly comprises a plurality of wheel assemblies, and one tandem wheel assembly of the plurality of wheel assemblies in the first configuration, and a second tandem wheel assembly of the plurality of wheel assemblies is in the second configuration, another tandem wheel assembly of the of the plurality of wheel assemblies is further selectively connected to the frame in third configuration where the other tandem wheel assembly is connected to the frame such that first and second wheel thereof are disposed inwardly from a longitudinal center plane of the track system and towards the vehicle.

According to another aspect of the present technology, there is provided a vehicle including a frame, at least one track system according to the above aspect or according to the above aspect and one or more of the above embodiments operatively connected to the frame; and a powertrain supported by the frame and configured to generate power and transmit said power to the at least one track system.

In some embodiments, the at least one track system is a plurality of track system comprising a first track system and a second track system, the first track system comprises a first tandem wheel assembly, and the second track system comprises a second tandem wheel assembly.

In some embodiments, the first and second wheel assemblies are in a first configuration, in which the first and second wheel assemblies are connected to the frame such that first and second wheel thereof are disposed inwardly from a longitudinal center plane of the track system and toward the vehicle.

In some embodiments, the first and second wheel assemblies are in a second configuration, in which the first and second wheel assemblies are connected to the frame such that first and second wheel thereof are disposed outwardly from a longitudinal center plane of the track system and away from the vehicle.

In some embodiments, the first and second track systems are one of: front track systems of the vehicle, rear track systems of the vehicle, right track systems of the vehicle, and left track systems of the vehicle.

According to another aspect of the present technology, there is provided a method for adjusting a traction of a vehicle, the method comprising: providing a tandem wheel assembly of claim 1, the tandem wheel assembly being removably connected a track system operatively connected to the vehicle in a first configuration such that first and second wheels thereof are disposed inwardly from a longitudinal center plane of the track system and towards the vehicle; disconnecting the tandem wheel assembly from the track system; and reconnecting the tandem wheel assembly to the track system in a second configuration such that first and second wheels thereof are disposed outwardly from the longitudinal center plane of the track system and away from the vehicle.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A is a left side elevation view of a vehicle having track systems according to embodiments of the present technology;

FIG. 1B is a top plan view of the vehicle of FIG. 1A;

FIG. 2A is a perspective view taken from a front, bottom, right side of a front track system of FIG. 1A without the endless track;

FIG. 2B is a left side elevation view a rear track system according to an embodiment of the present technology of the vehicle of FIG. 1A;

FIG. 3A is a perspective view of a symmetrical tandem assembly, without corresponding wheels, for a track system known in the art;

FIG. 3B is a top plan view of the symmetrical tandem assembly of FIG. 3A;

FIG. 4A is a perspective view of an asymmetrical tandem assembly, without corresponding wheels, for a track system according to an embodiment of the present technology;

FIG. 4B is a top plan view of the wheel assembly of FIG. 4A;

FIGS. 5A-5D are schematic representations of top plan views of a vehicle including track systems that comprise tandem assemblies according to some embodiments of the present technology;

FIG. 6A is a schematic representation of a track system according to an embodiment of the present technology;

FIG. 6B is a schematic representation of a track system according to an other embodiment of the present technology;

FIG. 7A is a schematic representation of a top plan view of the tandem assembly of FIG. 4A;

FIG. 7B is a schematic representation of a top plan view of a tandem assembly according to some other non-limiting embodiments of the present technology;

FIG. 8A shows graphical representations of vertical displacements of components of the symmetrical wheel assembly of FIG. 3A;

FIG. 8B shows graphical representations of vertical displacements of components of the asymmetrical wheel assembly of FIG. 4A; and

FIG. 8C shows graphical representations comparing vertical displacements of FIGS. 8A and 8B and of components of a tandem assembly with wheels of different diameters.

### DETAILED DESCRIPTION

### Introduction

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation to the track system, such as “vertical”, “horizontal”, “forwardly”, “rearwardly”, “left”, “right”, “above” and “below”, are as they would be understood by a driver of a vehicle to which the track system is connected sitting thereon in an upright driving position, with the vehicle steered straight-ahead and being at rest on flat, level ground.

Generally, the present technology relates to track systems and various features thereof such as layouts of the track systems, support structures of track systems, tensioners for track systems, support and idler wheel assemblies of the track systems, wheels for track systems, drive wheel assemblies of track systems, mounting attachments for track systems, and endless tracks of track systems.

### Symmetrical Assemblies

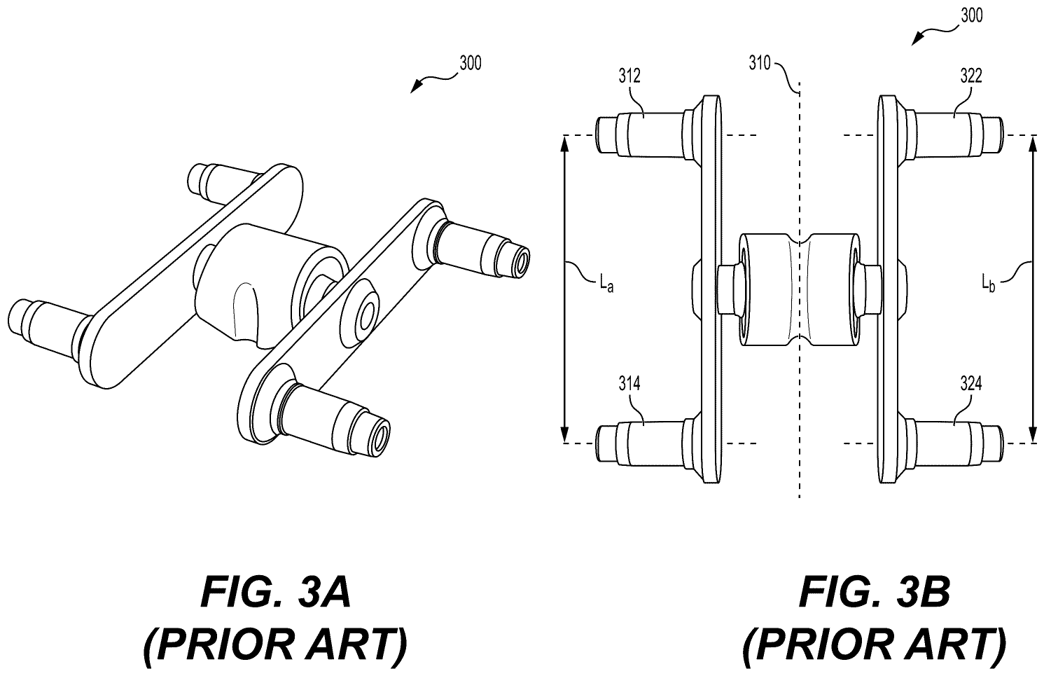

As depicted on FIGS. 3A and 3B, a symmetrical tandem assembly 300 is symmetrical with respect to a longitudinal center plane 310 of the assembly 300. More specifically, the symmetrical tandem assembly 300 includes first axles 312, 314 on a first side of the longitudinal center plane 310 and second axles 322, 324 on the other side of the longitudinal center plane 310. The symmetrical tandem assembly 300 is said to be symmetrical in that a longitudinal distance La between the axles 312, 314 is generally equal to a distance Lb between the axles 322, 324.

### Off-Road Vehicle

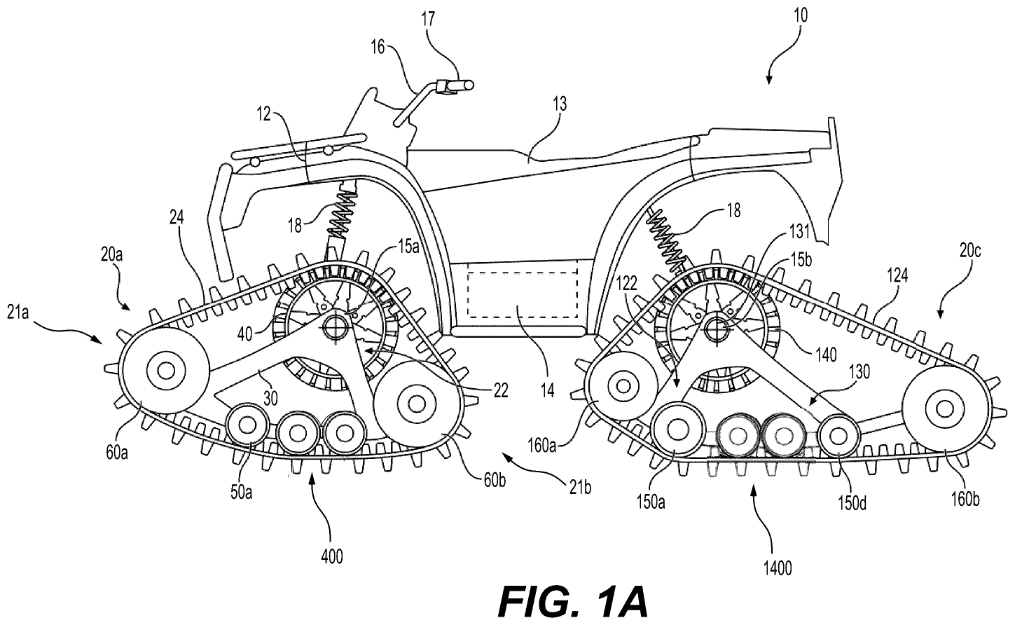

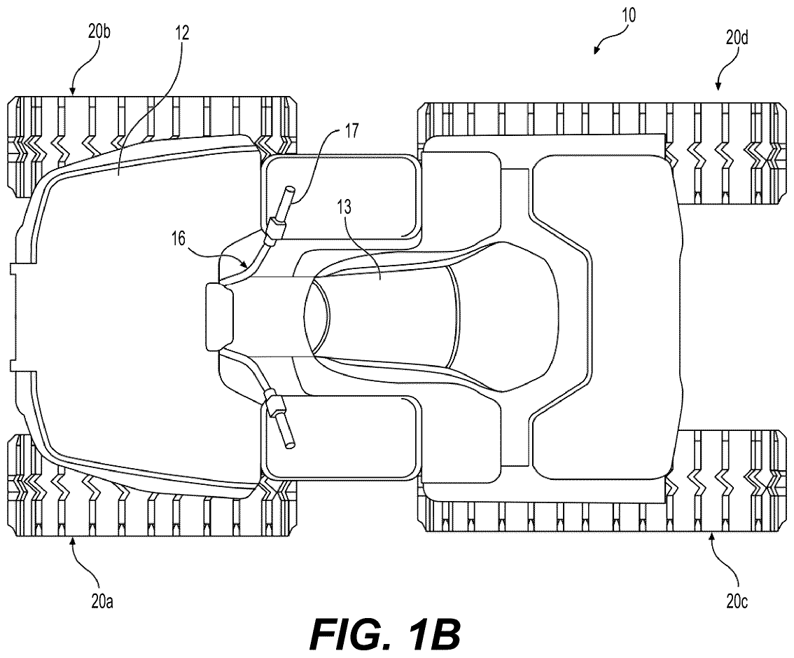

Referring to FIGS. 1A and 1B, the present technology will be described with reference to a vehicle 10. The vehicle 10 is an off-road vehicle 10. More precisely, the vehicle 10 is an all-terrain vehicle (ATV) 10. It is contemplated that in other embodiments, the off-road vehicle 10 could be as a snowmobile, a side-by-side vehicle, a utility-task vehicle (UTV) or another type of recreational vehicles. A person skilled in the art will understand that it is also contemplated that some aspects of the present technology in whole or in part could be applied to other types of vehicles such as, for example, agricultural vehicles, industrial vehicles, military vehicles or exploratory vehicles for examples. The off-road vehicle 10 has four track systems 20a, 20b, 20c, 20d in accordance with embodiments of the present technology. The track systems 20a, 20b are front track systems, and the track systems 20c, 20d are rear track systems. In some embodiments, the off-road vehicle 10 could have more or less than four track systems.

The off-road vehicle 10 includes a frame 12, a straddle seat 13 disposed on the frame 12, a powertrain 14 (shown schematically), a steering system 16, a suspension system 18, and the four track systems 20a, 20b, 20c, 20d.

As will be described below, in various embodiments, the track systems 20a, 20b, 20c, 20d may have various features to enhance their traction and/or other aspects of their use and/or performance, such as, for example, features to ameliorate their manoeuverability, to better adapt to ground, and/or to improve overall ride quality.

The powertrain 14, which is supported by the frame 12, is configured to generate power and transmit said power to the track systems 20a, 20b, 20c, 20d via driving axles (not shown), thereby driving the off-road vehicle 10. More precisely, the front track systems 20a, 20b are operatively connected to a front axle 15a and, the rear track systems 20c, 20d are operatively connected to a rear axle 15b. It is contemplated that in some embodiments, the powertrain 14 could be configured to provide its motive power to both the front and the rear axles 15a, 15b, to only the front axle 15a or to only the rear axle 15b (i.e., in some embodiments, the front axle and/or rear axle could be a driving axle).

The steering system 16 is configured to enable an operator of the off-road vehicle 10 to steer the off-road vehicle 10. To this end, the steering system 16 includes a handlebar 17 that is operable by the operator to direct the ATV 10 along a desired course. In other embodiments, the handlebar 17 could be replaced by another steering device such as, for instance, a steering wheel. The steering system 16 is configured so that in response to the operator handling the handlebar 17, the front track systems 20a, 20b to change their orientation relative to the frame 12, thereby causing the off-road vehicle 10 to turn in a desired direction.

The suspension system 18, which is connected between the frame 12 and the track systems 20a, 20b, 20c, 20d, allows relative motion between the frame 12 and the track systems 20a, 20b, 20c, 20d, and can enhance handling of the off-road vehicle 10 by absorbing shocks and helping to maintain adequate traction between the track systems 20a, 20b, 20c, 20d and the ground.

The track systems 20a, 20b, 20c, 20d are configured to compensate for and/or otherwise adapt to the suspension system 18 of the ATV 10. For instance, the track systems 20a, 20b, 20c, 20d are configured to compensate for and/or otherwise adapt to alignment settings, namely camber (i.e., a camber angle, “roll”), caster (i.e., a caster angle, “steering angle” and/or toe (i.e., a toe angle, “yaw”), which are implemented by the suspension system 18. As the off-road vehicle 10 could have been originally designed to use wheels instead of the track systems, the alignment settings could originally have been set to optimize travel, handling, ride quality, etc. of the off-road vehicle 10 with the use of wheels. Since the track systems 20a, 20b, 20c, 20d are structurally different and behave differently from wheels, the track system 20a, 20b, 20c, 20d may be configured to compensate for and/or otherwise adapt to the alignment settings to enhance their traction and/or other aspects of their performances and/or use.

### Track System

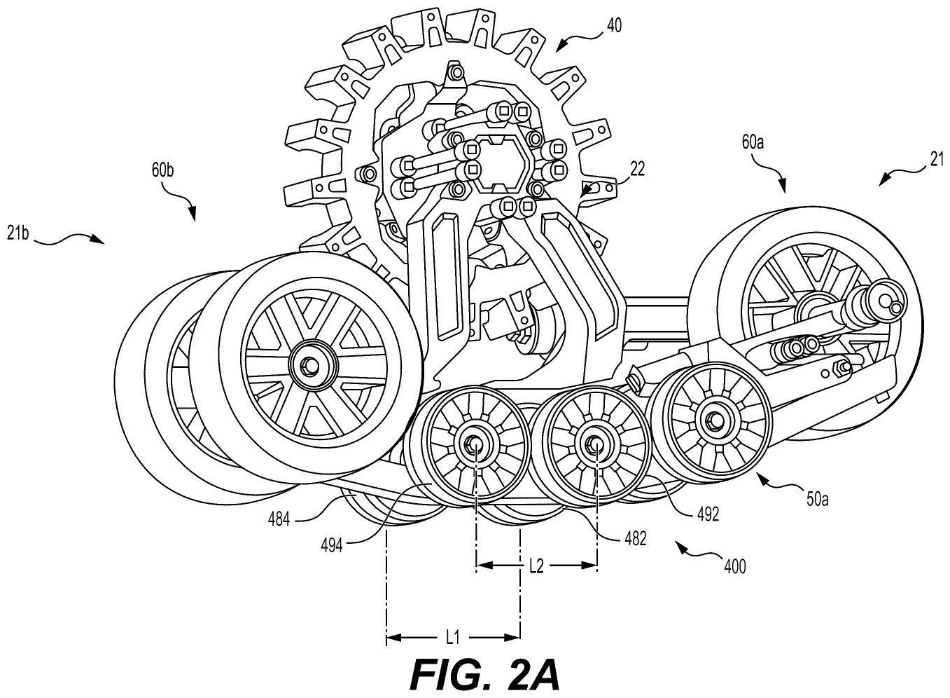

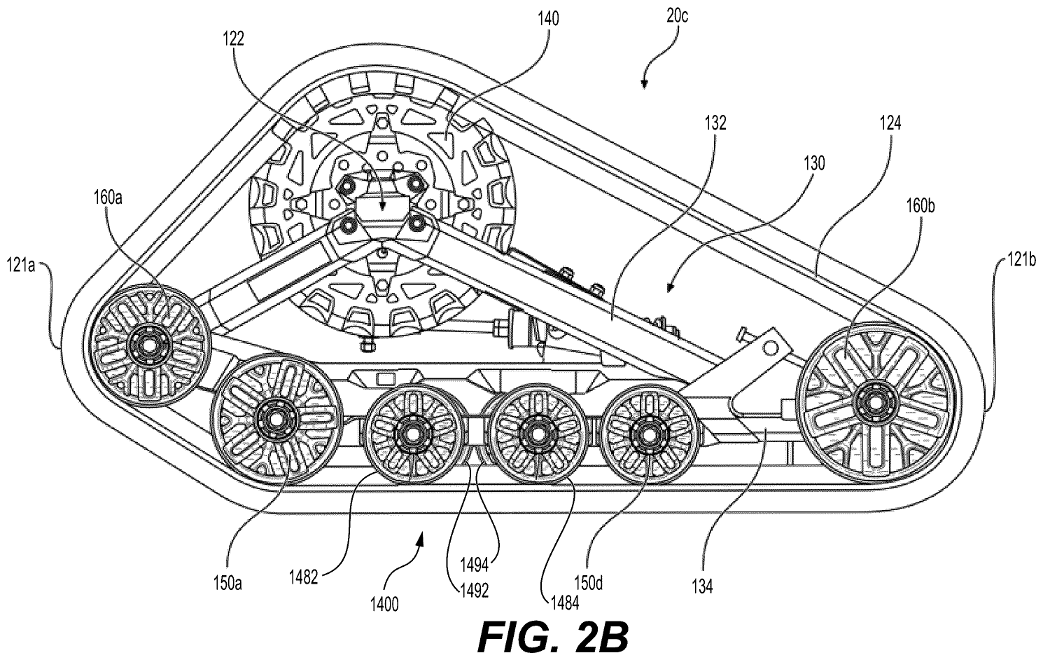

Referring to FIGS. 1A, 1B, 2A and 2B, the track systems 20a, 20b, 20c, 20d will now be generally described.

Focusing first on the front track systems 20a, 20b, and referring particularly to FIG. 2A, since the front track systems 20a, 20b are similar (i.e., generally symmetrical about a longitudinal center plane of the off-road vehicle 10), only the front track system 20a, will be described herewith. The track system 20a is a front left track system that is operatively connected to the off-road vehicle 10. In some instances, the front left track system 20a could be configured to replace a front left wheel of the off-road vehicle 10.

The track system 20a, which has a front longitudinal end 21a and a rear longitudinal end 21b, includes a track-engaging assembly 22. It should be noted that the endless track 24 that is disposed around the track-engaging assembly 22 is omitted in FIG. 2A. The track-engaging assembly 22 includes a frame 30, a drive wheel assembly 40, support wheel assemblies 50a and 400 and front and rear idler wheel assemblies 60a, 60b. As it will become apparent from the description herein further below, the support wheel assembly 400 is a tandem support wheel assembly of the front track system 20a.

It is contemplated that in some embodiments, there could be more or less than two idler wheel assemblies. In the present embodiment, each of the support wheel assembly 50a, and front and rear idler wheel assemblies 60a, 60b includes left and right wheels. As it will be described in greater details therein further below, in the present embodiment, the tandem support wheel assembly 400 comprises a pair of left wheels 482, 484 and a pair of right wheels 492, 494. Other configurations of the support and idler wheel assemblies are contemplated.

As shown in FIG. 2A, the front and rear idler wheel assemblies 60a, 60b are elevated relative to the support wheel assemblies 50a, and 400 and the support wheel 50a is elevated relative to the tandem wheel assembly 400. The elevation of the front idler wheel assembly 60a, and the support wheel 50a can, in some instances, help the track system 20a to overcome obstacles (i.e., increase approach angle) and/or help the track system 20a to steer (i.e., minimize ground contacting surface). The same applies for the elevation of the rear idler wheel assembly 60b as well (i.e., increase departure angle). In some embodiments, the front idler wheel assembly 60a and/or the rear idler wheel assembly 60b could bear weight, and thus could be considered to be support wheel assemblies. In some embodiments, the track system 20a includes an anti-rotation connector (not shown) as known in the art to limit a pivotal movement of the track system 20a relative to the frame 12 of the ATV 10. In some embodiments, the anti-rotation connector includes a resilient element such as a spring, or a member made of flexible material such as rubber, and a damper. The anti-rotation connector is connected between the frame 30 of the track system 20a and the frame 12 of the ATV 10. In some embodiments, the anti-rotation connector could be omitted. In some embodiments, one or more of the support wheels 50a, 50b and 50c could be elevated relative to the other support wheels.

Turning now particularly to FIG. 2B, as the rear track systems 20c, 20d are similar (i.e., generally symmetrical about a longitudinal center plane of the ATV 10), only the rear track system 20c will be described herewith. The track system 20c is a rear left track system configured to operatively connect to the ATV 10. In some instances, the rear left track system 20c is configured to replace a rear left wheel of the ATV 10.

The track system 20c, which has a front longitudinal end 121a and a rear longitudinal end 121b, includes a track-engaging assembly 122 and an endless track 124 disposed around the track-engaging assembly 122. The track-engaging assembly 122 includes a frame 130, a drive wheel assembly 140, support wheel assemblies 150a, 1400 and 150d, and front and rear idler wheel assemblies 160a, 160b. As it will become apparent from the description herein further below, the support wheel assembly 1400 is a tandem support wheel assembly of the rear track system 20c. In the present embodiment, the tandem support wheel assembly 1400 comprises a pair of left wheels 1482, 1484 and a pair of right wheels 1492, 1494.

In the embodiment shown in FIG. 2B, the front idler wheel assembly 160a is elevated relative to the support wheel assemblies 150a, 1400 and 150d. In some embodiments, the support wheel assembly 150a could be elevated relative to the support wheel assemblies 1400, 150d as well. The elevation of the front idler wheel assembly 160a can, in some instances, assist the track system 20c to overcome obstacles (i.e., increase approach angle). The same applies for the elevation of the support wheel assembly 150a (i.e., increase approach angle) and for the elevation of the rear idler wheel 160b as well (i.e., increase departure angle). As will be described in greater detail below, the configuration of the support wheel assemblies 150a, 1400, 150d and the front and rear idler wheel assemblies 160a, 160b could be different. In some embodiments, the front idler wheel assembly 160a and/or the rear idler wheel assembly 160b could bear weight, and thus could be considered to be support wheel assemblies. In some embodiments, the anti-rotation connector includes a resilient element such as a spring, or a member made of flexible material such as rubber, and a damper. The anti-rotation connector is connected between the frame 130 of the track system 20c and the frame 12 of the ATV 10. In some embodiments, the anti-rotation connector could be omitted.

As it will now be discussed in greater details herein further below, the tandem support wheel assembly 400 of the front track system 20a and the tandem support wheel assembly 1400 of the rear track system 20c are configured as “asymmetrical” tandem assemblies. It can be said that axles of a pair of wheels of the tandem support wheel assemblies 400, 1400, on one side of the frame 30, 130 are spaced apart by a first longitudinal distance, while axles of another pair of wheels of the tandem support wheel assemblies 400, 1400 on the other side of the frame 30, 130 are spaced apart by a second longitudinal distance, that is different from the first longitudinal distance.

Developers have realized that providing a given track system on a given tracked vehicle with at least one asymmetrical tandem assembly may aid in reducing vibration in that track system and/or the corresponding tracked vehicle.

It should be noted that some portions of the endless track are comparatively more rigid than other portions of the endless track. The endless track is more flexible at the comparatively less rigid portions thereof. Therefore, it can be said that the endless track has a “rigidity pattern” along its length, such that the rigidity of the endless track varies from one portion to another. In some cases, it can be said that the endless track has a constant “rigidity pitch” along its length, such that the rigidity of the endless track changes periodically along the length of the endless track.

In some embodiments, a rigidity pattern/pitch of the endless track may depend on inter alia a given tread pattern/pitch of the ground-engaging lugs of the endless track. In one non-limiting example, the rigidity pitch of the endless track can match the tread pitch of the ground-engaging lugs of the endless track, although this may not be the case in each and every embodiment of the present technology. It should be expressly understood that one or more additional characteristics, other than the tread pattern/pitch of the endless track, may influence the specific rigidity pattern/pitch of that endless track.

Developers have realized that a given rigidity pattern/pitch of a given endless track causes vibrations to be propagated as the support wheels roll over the inner surface of the given endless track. For example, when a support wheel rolls at a given speed on the given endless track with the given rigidity pattern/pitch, the given wheel may generate frequencies that are close and/or match a natural frequency of the given endless track and/or of the corresponding tracked vehicle. It should be noted that vibrations of the track system may adversely affect the ride quality and/or durability of certain components of the track system and/or of the corresponding tracked vehicle.

Developers of the present technology have realized that asymmetrical tandem assemblies such as the tandem assemblies 400, 1400, and 400′ may provide a comparatively better reducing in vibrations caused during operation than some conventional tandem assemblies, such as the symmetrical tandem assembly 300 of FIGS. 3A and 3B, for example, where the distances between axles on respective sides of the symmetrical tandem assembly are the same.

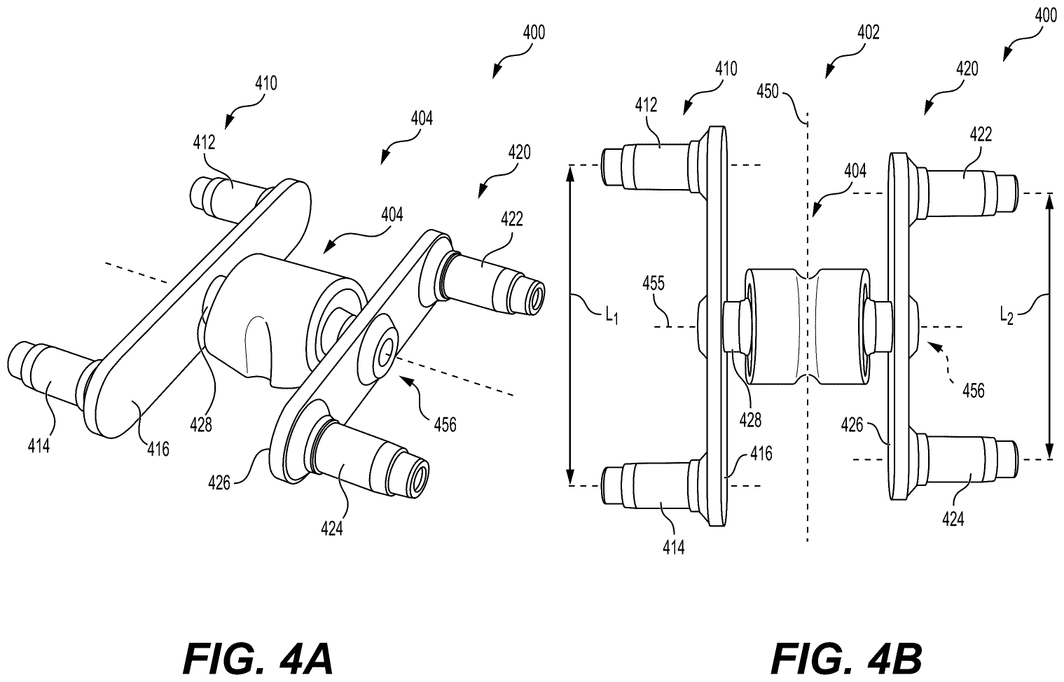

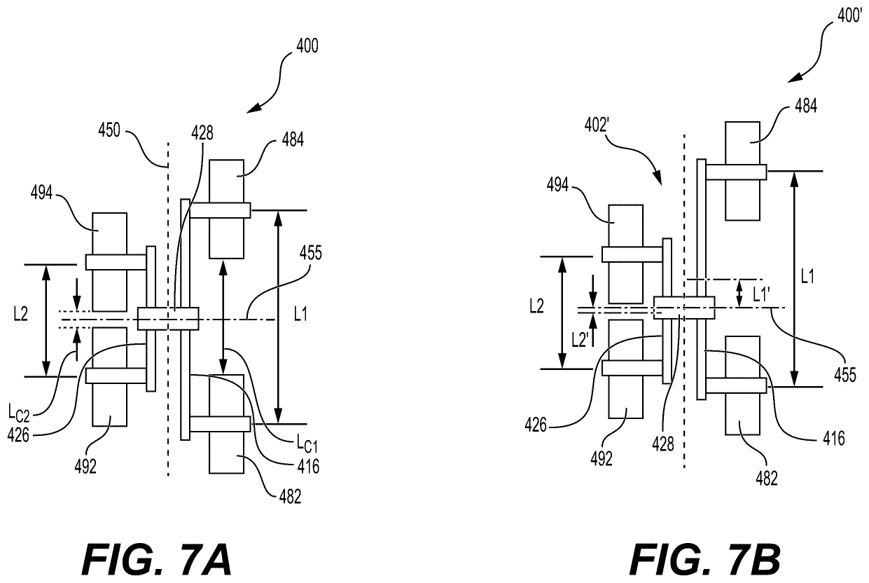

With reference to FIGS. 4A, 4B and 7A, there is depicted an asymmetrical tandem assembly 400. It should be noted that components of the asymmetrical tandem assembly 1400 of the rear track system 20c may be similar to components of the asymmetrical tandem assembly 400 of the front track system 20a. Therefore, only the asymmetrical tandem assembly 400 will be discussed in greater details for the sake of brevity.

The tandem assembly 400 may be for example and without limitation implemented in a track system for a vehicle. As best shown on FIGS. 4B and 7A, the asymmetrical tandem assembly 400 is asymmetrical with respect to a longitudinal center plane 450. As will be described in greater details hereinafter, the asymmetrical tandem assembly 400 comprises a wheel-carrying structure 402 including a first portion 410 extending on one side of the longitudinal center plane 450, and a second portion 420 extending on the other side of the longitudinal center plane 450. The first and second portions 410 are connected to one another by a connecting member 428.

A first axle 412 and a second axle 414 extend from a carrying-arm 416 of the first portion 410, and a third axle 422 and a fourth axle 424 extend from a carrying-arm 426 of the second portion 420. A longitudinal distance between the first axle 412 and the second axle 414 is denoted L₁ and is different from a longitudinal distance, denoted L₂, between the third axle 422 and the fourth axle 424. In this embodiment, the longitudinal distance L₁ between the first axle 412 and the second axle 414 is greater than the longitudinal distance L₂ between the first axle 422 and the second axle 424. This aspect is not limitative, alternative embodiments where L₁ is smaller than L₂ are also contemplated.

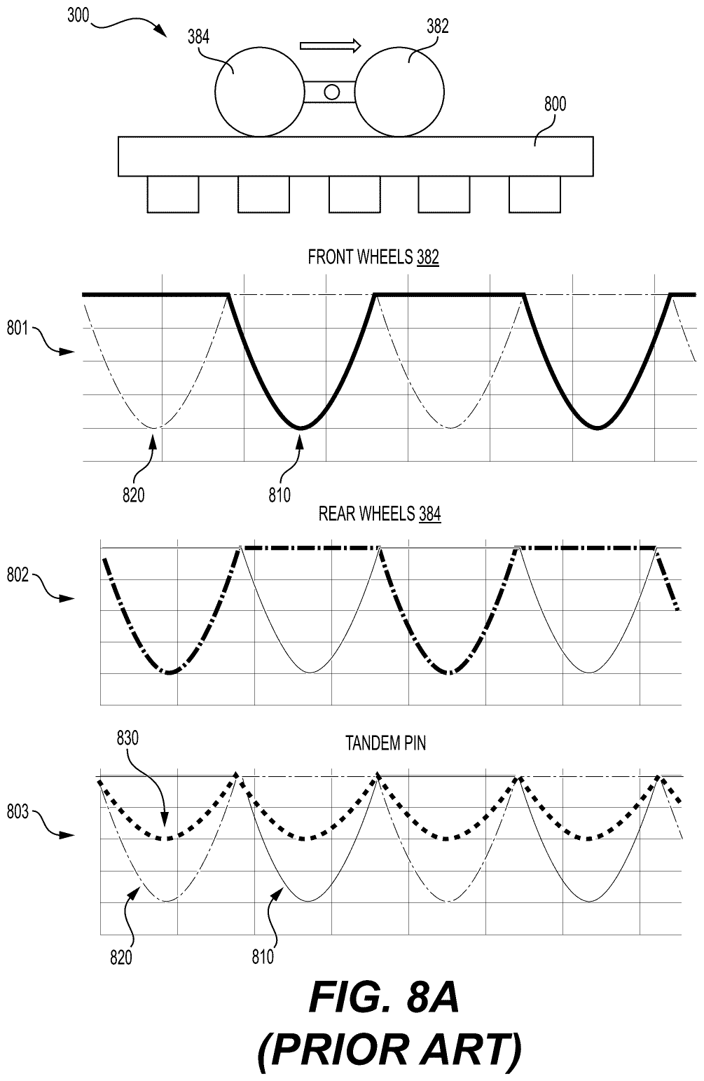

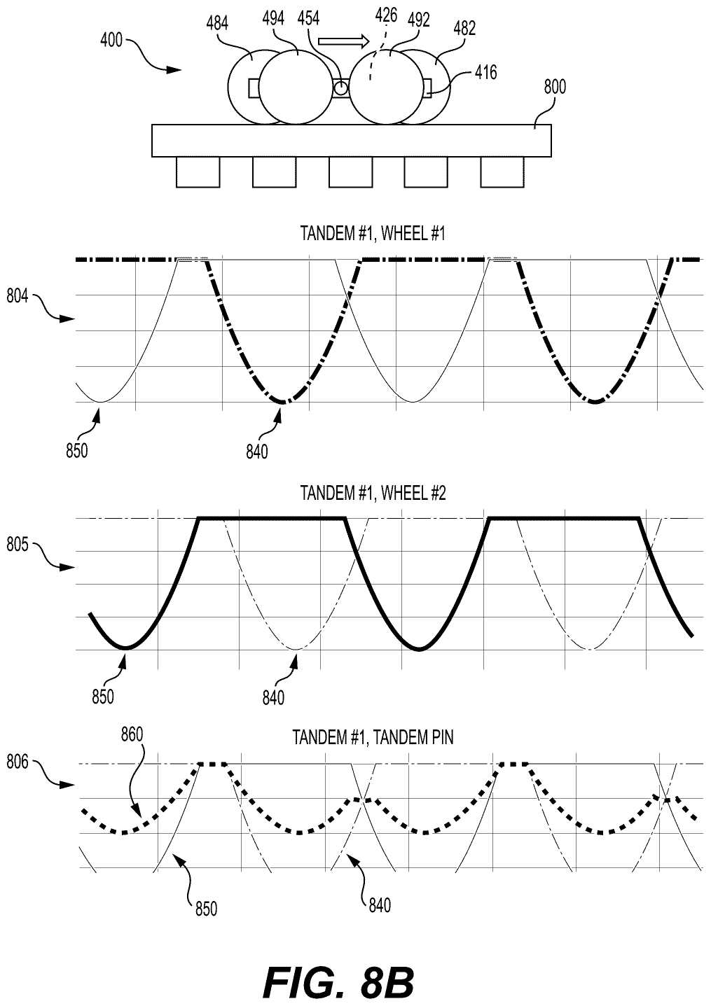

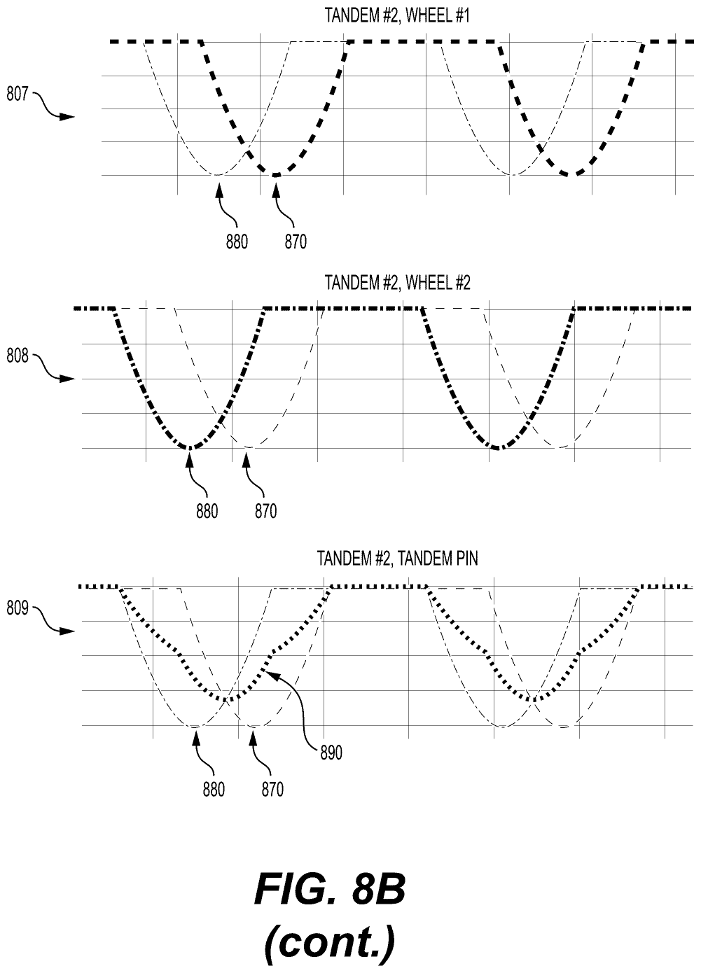

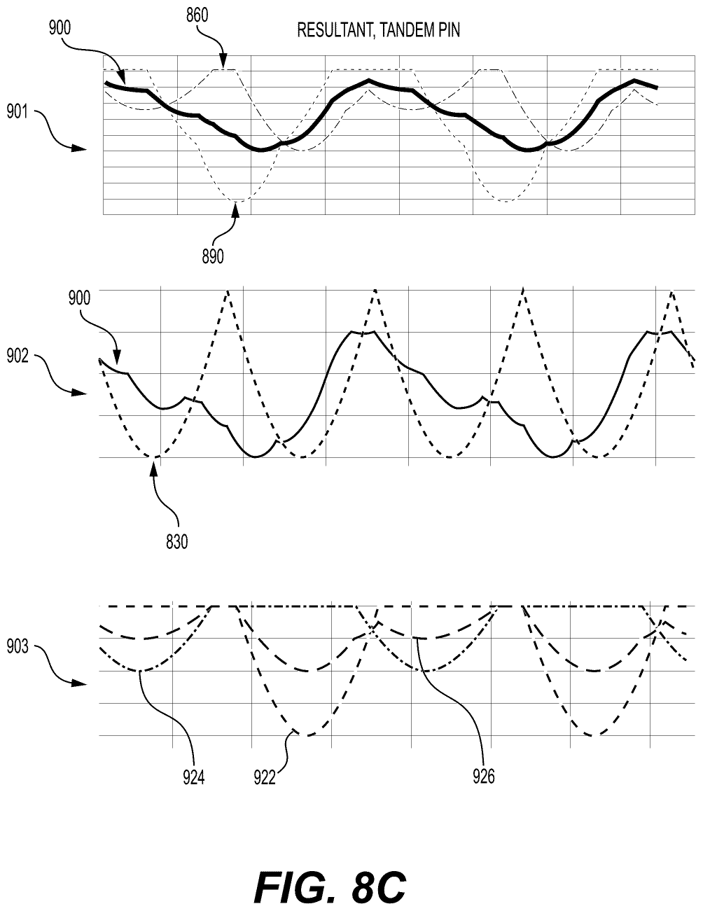

FIGS. 8A, 8B and 8C represent variations of positions of various components of different wheel mounting assemblies during operation. Without being bound to any specific theory, an endless track 800 has an inner surface on which the support wheels roll on and an outer surface defining longitudinally spaced ground-engaging lugs and inter-lug portions therebetween. For illustrative purposes only, the non-limiting examples in FIGS. 8A, 8B, and 8C are provided with respect to the endless track 800 having a rigidity pattern/pitch that matches the tread pattern/pitch of the ground-engaging lugs of the endless track 800. However, this may not be the case in each and every embodiment of the present technology.

In this non-limiting example, the endless track 800 has a rigidity that varies along its longitudinal direction due to the ground-engaging lugs that are more rigid than the inter-lug portions that are less rigid and allow the endless track to flex with more case. This comparative difference in rigidity (rigidity pattern of the endless track 800) can generate a constant excitation as the wheels roll over the inner surface of the endless track 800, which can adversely affect the ride quality and durability of certain components of the track system and/or the vehicle. It is thus understood that the variation of rigidity of the endless track 800 in its longitudinal direction generates vertical displacement of the wheels relative to the axle of a given tandem assembly they are pivotably mounted to. The vertical displacement of wheels mounted on the axles of tandem assemblies while rolling on the inner surface of the endless track 800 has been simulated for different configurations.

Graphs of FIG. 8A represent variations in vertical position of elements of the symmetrical tandem assembly 300 of FIGS. 3A and 3B with front wheels 382 and rear wheels 384 (only one of the two front wheels 382 and one of the two rear wheels can be seen on FIG. 8A) mounted thereon and an endless track 800 engaging said front and rear wheels 382, 384. The vertical position varies as the assembly 300 rolls over the inner surface of the endless track 800. In use, the front wheels are mounted on the axles 312, 322, and the rear wheels 384 are mounted on the axles 314, 324.

In this illustrative example, the longitudinal distance Lab is offset with the rigidity pitch (in this case, the rigidity pitch matches the tread pitch which is the distance between two adjacent ground-engaging lugs), which provides some reduction of the vibration compared to a situation where the longitudinal distance Lab is equal to said rigidity pitch and/or to a discrete multiple of the rigidity pitch.

Graph 801 shows inter alia a curve 810 (bolded) that represents a vertical displacement of the front wheels 382 of the conventional tandem assembly 300 rolling on the endless track 800 having a constant rigidity pattern/pitch. Graph 802 shows inter alia a curve 820 (bolded) that represents a vertical displacement of the rear wheels 384 of the conventional tandem assembly 300 rolling on the endless track 800 having a constant rigidity pattern/pitch. As seen on both the graphs 801 and 802, the vertical displacement of the front wheels 382 (i.e., the curve 810) and the vertical displacement of the rear wheels 384 (i.e., the curve 820) are periodical and have opposite phases due to the mismatch of the longitudinal distance Lab and the rigidity pitch of the endless track 800 (in this example, the tread pitch of the ground-engaging lugs).

Graph 803 shows inter alia a curve 830 (bolded) that represents a vertical displacement of a tandem pin of the conventional tandem assembly 300 when rolling on the endless track 800 having a constant rigidity pattern/pitch. The curve 830 can be said to be a resultant of vertical displacement of front and rear wheels 382, 384 (i.e., resultant of the curves 810 and 820). As seen in the graph 803, the symmetrical tandem assembly 300 undergoes relatively high amount of periodic movements or vibrations, which may result in a resonant phenomenon that may damage the symmetrical tandem assembly 300, the track system comprising it, and a vehicle comprising said track system, in some cases.

Graphs of FIG. 8B represent a variation in vertical position of elements of the asymmetrical tandem assembly 400 of FIGS. 4A, 4B and 7A with a first front wheel 482 mounted on the first axle 412, a second front wheel 492 mounted on the first axle 422, a first rear wheel 484 mounted on the second axle 414 and a second rear wheel 494 mounted on the second axle 424. The endless track 800 engages said front and rear wheels 412, 422, and 484, 494, respectively. The vertical position varies as the assembly 400 rolls over an inner surface of the endless track 800.

Graph 804 shows inter alia a curve 840 (bolded) that represents a vertical displacement of the front wheel 492 of the tandem arm 426 rolling on an endless track 800 having a constant rigidity pattern/pitch. Graph 805 shows inter alia a curve 850 (bolded) that represents a vertical displacement of the rear wheel 494 of the tandem arm 426 rolling on the endless track 800 having a constant rigidity pattern/pitch. The curves 840 and 850 are periodical and have a first phase shift due to the difference between (i) the distance between the front wheel 492 and the second rear wheel 494 and (ii) the rigidity pitch of the endless track 800.

Graph 806 shows inter alia a curve 860 (bolded) that represents a vertical displacement of the tandem pin 456 connecting the connecting member 428 to the tandem arm 426 when rolling on the endless track 800 having a constant rigidity pattern/pitch. It can be said that the curve 860 is a resultant of the vertical displacement of the front and rear wheels 492, 494 of the tandem arm 426 (i.e., resultant of the curves 840 and 850).

Graph 807 shows inter alia a curve 870 (bolded) that represents a vertical displacement of the front wheel 482 of the tandem arm 416 rolling on the endless track 800 having a constant rigidity pattern/pitch. Graph 808 shows inter alia a curve 880 (bolded) that represents a vertical displacement of the rear wheel 484 of the tandem arm 416 rolling on the endless track 800 having a constant rigidity pattern/pitch. It should be noted that the tandem arm 416 is asymmetrical compared to the tandem arm 426. The curves 870 and 880 are periodical and have a second phase shift due to the difference between (i) the distance between the front wheel 482 and the rear wheel 484 and (ii) the rigidity pitch of the endless track 800.

Graph 809 shows inter alia a curve 890 (bolded) that represents a vertical displacement of the tandem pin 456 connecting the connecting member 428 to the tandem arm 416 when rolling on the endless track 800 having a constant rigidity pattern/pitch. It can be said that the curve 890 is a resultant of vertical displacement of the front and rear wheels 482, 484 of tandem arm 416 (i.e., resultant of the curves 870 and 880).

With reference to FIG. 8C, graph 901 shows inter alia a curve 900 (bolded) that represents a vertical displacement of the tandem pin 456 of the asymmetrical tandem assembly 400 when rolling on the endless track 800 having a constant rigidity pattern/pitch. It can be said that the curve 900 is a resultant of vertical displacement of the wheels 482, 484, 492, 494 of the asymmetrical tandem assembly 400 (i.e., a resultant of the curves 860 and 890).

Developers have realized that by having asymmetrical tandem assemblies, the vibration pattern of the tandem assembly is modified. Said asymmetry causes a phase shift of the excitation from the constant rigidity pitch of the endless track 800. This results in an at least partial cancellation of the excitation by reducing at least partially its amplitude and/or its frequency. In use, the asymmetrical tandem assembly 400 may also help to distribute loads of a track system thereof, or even of the vehicle, on the inner surface of the endless track in a way that could reduce premature wear of the endless track.

Graph 902 is a comparison between the curve 830, representing the vertical displacement of the tandem pin of the conventional symmetrical tandem assembly 300 when rolling on the endless track 800 having a constant rigidity pattern/pitch, and the curve 900, representing a vertical displacement of the tandem pin 456 of the asymmetrical tandem assembly 400 when rolling on the endless track 800 having a constant rigidity pattern/pitch. Without being bound to any specific theory, in this example, it can be seen that the asymmetrical tandem assembly 400 may reduce amplitude of vibrations, in both amplitude and frequency compared to the symmetrical tandem assembly 300. In some implementations, the amplitude of the vibrations may be reduced by up to approximately 21%.

Developers of the present technology have realized that different configurations may generate different changes in the vibration pattern. For example, if the diameter of one of the inner and outer sets of wheels have a diameters different from the diameter of the other one of the inner and outer sets of wheels, the vibration pattern can be affected. Graph 903 shows a curve 924 that represents a vertical displacement of a first wheel, a curve 922 that represents a vertical displacement of a second wheel, and a curve 926 that represents a vertical displacement of the tandem pin 456 connecting the carrying-arms 416, 426 of the first and second, front and rear wheels. In this example, the diameter of the first wheel is twice the diameter of the second wheel.

Referring back to FIGS. 4A, 4B and 7A, the asymmetrical tandem assembly 400 is a wheel assembly including a wheel-carrying structure 402 pivotably connectable to a frame of a corresponding track system, such as the frame 30 of the track system 20a, or the frame 130 of the track system 20c. The wheel assembly 400 includes a resilient member 404 that may, in use, be selectively at least indirectly connected to said frame. In this embodiment, the resilient member 404 is connected to the connecting member 428 of the wheel assembly 400. For example and without limitation, the resilient member 404 may be made of a resilient material such as rubber. In some cases, the resilient member 404 can be omitted.

It should be noted that, in some embodiments, the resilient member 404 may permit a resilient pivoting movement of the asymmetrical tandem assembly 400 along a longitudinal axis thereof and/or along a lateral axis thereof and bias the asymmetrical tandem assembly 400 towards its nominal position (i.e. at rest).

As shown on FIGS. 4A and 4B, the wheel-carrying structure 402 includes a first portion 410 extending on one side of the wheel-carrying structure 402, and a second portion 420 extending on the other side of the wheel-carrying structure 402.

In some embodiments, the first and second portions 410, 420 may be pivotably connected to the connecting member 428 and are configured to pivot independent from one another relative to the connecting member 428. For example, the connecting member 428 may be embodied as a shaft pivotably connecting the first and second portions via a tandem pin 456, to provide a pivot for the first and second carrying-arms 416, 426 about the lateral center plane 455.

In other embodiments, the first and second portions 410, 420 may be integrally formed with the connecting member 428. In these embodiments, the wheel-carrying structure 402 may be configured to pivot relative to the frame 30 as a single, integral unit due to the resilient and pivoting connection of the wheel-carrying structure 402 to the frame 30 via the resilient member 404.

As will be described in greater details herein after, the asymmetrical tandem assembly 400 may be selectively removably connectable to the frame in one of a first orientation and a second orientation. As such, the asymmetrical tandem assembly 400 and the track systems including said asymmetrical tandem assembly 400 may be said to be “swappable” and/or “reversible”. Indeed, it should be noted that two asymmetrical tandem assemblies 400 of a same track system or from different track system of a same or different tracked vehicle may be swapped together, without departing from the scope of the present technology.

In some embodiments, the first and second portions 410, 420 respectively include the first and second carrying arms 416, 426 that extend longitudinally. Other shapes of the first and second portions 410, 420 are contemplated in alternative embodiments. For example the first and second carrying arms 416, 426 may have a generally curved-shape.

As previously alluded to, in some embodiments, the first and second portions 410, 420 may be pivotably connected to the connecting member 428. More specifically in this embodiment, the first and second carrying-arms 416, 426 may pivot relatively to the connecting member 428 independently from each other. In other words, pivoting movement of the first and second carrying-arms 416, 426 can be independent.

Also as previously alluded to, in other embodiments, the first and second carrying-arms 416, 426 are fixedly connected (e.g., welded) to the connecting member 428. In further embodiments, only a single one of the first and second carrying-arms 416, 426 may pivot relative to the connecting member 428 while the other one of the first and second carrying-arms 416, 426 is fixedly connected to the connecting member 428.

The first carrying-arm 416 defines a first axle 412 and a second axle 414 separated by a first longitudinal distance L₁. The first and second axles 412, 414 extend laterally away from the first carrying-arm 416. In use, a first wheel and a second wheel may rotationally be connected to the first axle 412 and a second axle 414 respectively, the first wheel being thus longitudinally spaced by the first distance L₁ from the second wheel.

Rotational axes of the axles 412, 414 and/or of the corresponding wheels are parallel and spaced apart by the first longitudinal distance L₁.

The second carrying-arm 426 defines a first axle 422 and a second axle 424 separated by a second longitudinal distance L₂. The first and second axles 422, 424 may extend laterally away from the second carrying-arm 426. In use, a third wheel and a fourth wheel may rotationally be connected to the first axle 422 and a second axle 424 respectively, the third wheel being thus longitudinally spaced by the first distance L₂ from the fourth wheel. Rotational axes of the axles 422, 424 and/or of the corresponding wheels are parallel and spaced apart by the second longitudinal distance L₂.

The second longitudinal distance L₂ is different from the first longitudinal distance L₁, forming an asymmetry relative to a longitudinal center plane 450. In this non-limitative embodiment, the second longitudinal distance L₂ is shorter than the first longitudinal distance L₁. In this embodiment, and as best shown on FIG. 4B, the wheel-carrying structure 402 is symmetrical about a lateral center plane 455 of the wheel-carrying structure 402, however, this may not be the case in each and every embodiment of the present technology as it will be described in greater detail herein further below with reference to FIG. 7B.

Referring to FIG. 4B, at least one of the first longitudinal distance L₁ and the second longitudinal distance L₂ may be different from a rigidity pitch of the endless track 24 of the track system. It should also be understood that different ratios of longitudinal distances L₁/L₂ may produce different results with respect to minimizing structural vibrations. For example and without limitations, L₁ may be between 135 mm and 165 mm, and L₂ may be between 157 mm and 193 mm. L₁ may be 150 mm (+−10% approximately), and L₂ may be 174 mm (+−10% approximately). In this example, the diameter of a corresponding wheel may be about 133 mm. The longitudinal distances L₁ and L₂ and the ratio thereof may be designed based on a pitch of the ground-engaging lugs, the available space and diameter of the wheels to avoid contact therebetween and/or any other mechanical constraints of the vehicle 10.

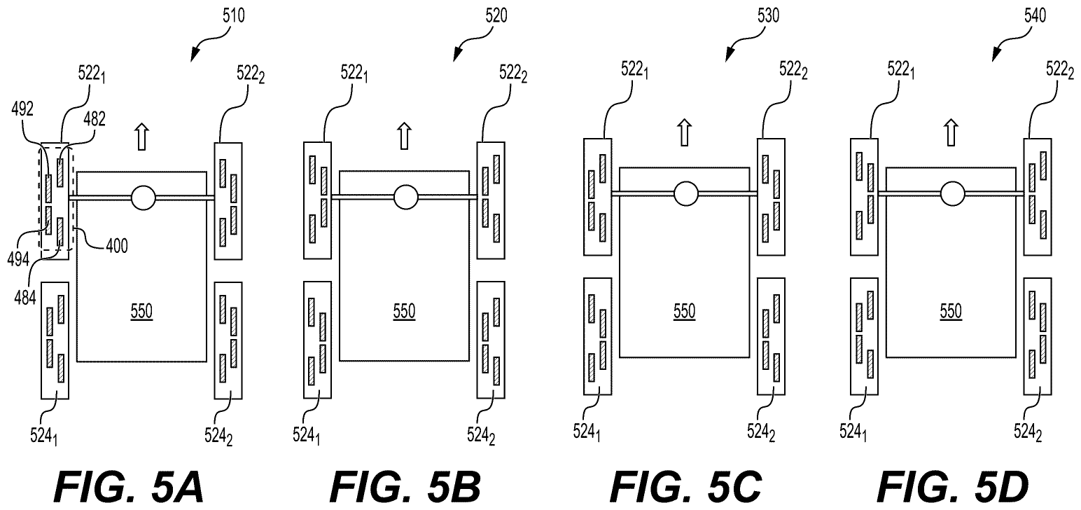

With reference to FIGS. 5A to 5D, there are depicted schematic representations of at least some configurations, 510 to 540 respectively, of asymmetrical tandem assemblies in which they can be used on front and/or rear track systems of a tracked vehicle 550.

In use, the asymmetrical tandem assembly 400 may be selectively connectable to the frame 30 of the track system 20 of the vehicle 10 in a first or a second orientation. In the first orientation, the portion having the longest distance (amongst L₁ and L₂) between its axles is disposed inwardly from the longitudinal center plane of the track system 20 and towards the vehicle 10. In configuration 510 shown on FIG. 5A, the tracked vehicle 550 includes left and right front track systems 5221, 5222 provided with asymmetrical assemblies 400 in a “long-side inside” configuration where the “short side” thereof is oriented toward an outer side of the corresponding frames 30 and the “long side” thereof is oriented toward an inner side of the corresponding frames 30. In such configuration, the asymmetrical assembly may allow minimizing friction (scrubbing effect) during steering if the projected steering axis on the inner surface of the endless track is located inwardly of the longitudinal center plane of the track system. In this configuration 510, the tracked vehicle 550 also includes left and right rear track systems 5241, 5242 provided with asymmetrical assemblies 400 in the “long-side inside” configuration.

In the second orientation, the portion having the longest distance (amongst L₁ and L₂) between its axles is disposed outwards from the longitudinal center plane of the track system 20 and away from the vehicle 10. Each orientation may be referred to as a “configuration” of the asymmetrical tandem assembly 400 with respect to the frame 30. In other words, in the first orientation the first portion 410 of the wheel-carrying structure 402 is disposed on a first side of the frame 30, and, in the second orientation, the second portion 420 of the wheel-carrying structure 402 is disposed on the first side of the frame 30. In some embodiments, the asymmetrical assembly 400 is removably connectable to the frame 30 of the track system. In configuration 520 of FIG. 5B, the left and right front track systems 5221, 5222 and the left and right rear track systems 5241, 5242 are provided with asymmetrical assemblies 400 in a “short-side inside” configuration where the “short side” thereof is disposed on an inner side of the corresponding frames 30, 130 and the “long side” thereof is oriented toward an outer side of the corresponding frames.

In configuration 530 of FIG. 5C, the left and right front track systems 5221, 5222 are provided with asymmetrical tandem assemblies 400 in the “long-side inside” configuration and the left and right rear track systems 5241, 5242 provided with asymmetrical assemblies 400 in the “short-side inside” configuration.

In configuration 540 of FIG. 5D, the left and right front track systems 5221, 5222 are provided with asymmetrical assemblies 400 in the “short-side inside” configuration, and the left and right rear track systems 5241, 5242 provided with asymmetrical assemblies 400 in the “long-side inside” configuration.

Other configurations are also contemplated in alternative embodiments. A selection of the configuration of the track systems for a given tracked vehicle may depend on a plurality of factors, such as, for example and without limitations, a space available to accommodate the track systems, a camber angle of the wheels mounted on the asymmetrical tandem assemblies and a magnitude thereof, and any other parameters, such as conditions of use (e.g. hard surface, soft surface, mud, snow, pavement, trails, etc.), management of debris ingestion, for instance.

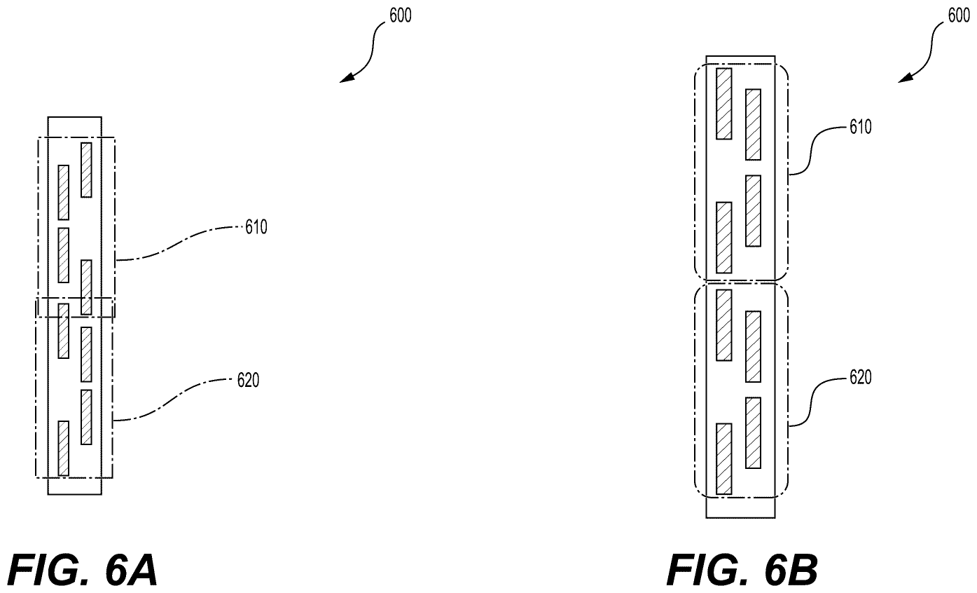

In some embodiments, a given track system of a vehicle such as the tracked vehicle 550 may include a plurality of tandem assemblies. With reference to FIG. 6A, there is depicted a track system 600 including a first asymmetrical tandem assembly 610 and a second asymmetrical tandem assembly 620. In FIG. 6A, the first and second asymmetrical tandem assemblies 610, 620 are provided in different configurations. (i.e., their respective “short side” are oriented toward opposed direction). For example, the first asymmetrical tandem assembly 610 may be in the “short-side inside” configuration and the second asymmetrical tandem assembly 620 in the “long-side inside” configuration. As another example, the first asymmetrical tandem assembly 610 may be in the “long-side inside” configuration and the second asymmetrical tandem assembly 620 in the “short-side inside” configuration. In some cases, alternating configurations of the first and second asymmetrical tandem assemblies can contribute to minimize the overall footprint or required space to operate of said asymmetrical tandem assemblies.

FIG. 6B depicts another embodiment of the track system 600 in which the first and second asymmetrical tandem assemblies 610, 620 are provided in a same configuration (i.e., their respective “short side” are oriented toward a same direction). For example, the first and second asymmetrical tandem assemblies 610, 620 may be both in the “short-side inside” configuration or both in the “long-side inside” configuration. In some cases, this configuration can contribute to distribute loads more evenly on the inner surface of the endless track, especially at the junction of the first and second asymmetrical tandem assemblies, compared to the exemplary embodiment shown on FIG. 6A, where there can be a concentration of load at the function of the first and second asymmetrical tandem assemblies in some cases.

It is contemplated that in at least some implementations of the present technology, employing an asymmetrical tandem assembly may contribute to reducing de-tracking, where the endless track comes off the track system and which requires maintenance and/or repair and/or replacement.

Asymmetrical tandem assemblies disclosed herein are swappable or reversible to provide opportunities to improve the performance of the track systems depending on the conditions of its use. For example, during the summer season (i.e., use on generally hard, muddy, or grassy grounds), having the asymmetrical tandem assemblies in the first configuration (i.e., their “short side” disposed on an outer side of the corresponding frame) may be preferable at least for front track systems for minimizing friction (scrubbing effect) during steering if the projected steering axis on the inner surface of the endless track is located inwardly of the longitudinal center plane of the track system.

Conversely, during the winter season, a longer length might be desirable on the outer side of the track system in order to “grab more snow” and thus improve traction while not increasing wear significatively. A user or an operator of the tracked vehicle could thus reverse the asymmetrical tandem assemblies of the front track systems to provide them with their asymmetrical tandem assemblies in the second configuration to maximize the performance of the track systems. It should also be noted that swapping of the tracked systems can be particularly interesting with vehicles having aggressive camber angles (positive or negative).

In one aspect, the present technology provides a method for adjusting a traction of a vehicle. The method includes providing the wheel assembly 400 or 400′ that is removably connected to the track system 20 in the “long-side inside” configuration (or the “short-side inside” configuration).

The method further includes disconnecting the wheel assembly 400 or 400′ from the track system 20 and reconnecting the wheel assembly 400 or 400′ to the track system 20 in the “short-side inside” configuration (or the “long-side inside” configuration respectively).

FIG. 7A is a schematic representation of a top view of the tandem assembly 400 with wheels 482, 484, 492 and 494 mounted thereon. As previously described, the wheel-carrying structure 402 is asymmetrical with respect to the longitudinal center plane 450 due to the difference between the first longitudinal distance L₁ and the second longitudinal distance L₂. The wheel-carrying structure 402 is also symmetrical with respect to the lateral center plane 455. In other words, a longitudinal distance between the pivot axis of the connecting member 428 and a rotation axis (i.e., the axis of the corresponding axle of the wheel-carrying structure 402) of the wheel 482 is equal to a longitudinal distance between the pivot axis of the connecting member 428 and a rotation axis of the wheel 484. Similarly, a longitudinal distance between the pivot axis of the connecting member 428 and a rotation axis of the wheel 492 is equal to a distance between the pivot axis of the connecting member 428 and a rotation axis of the wheel 494.

In use and as best shown on FIG. 7A, the longitudinal distance L₂ is a sum of (i) a radius of the wheel 492, (ii) a radius of the wheel 494 and (iii) a first longitudinal clearance distance L_{C2} between the wheels 492, 494. Similarly, the longitudinal distance L₁ is a sum of (i) a radius of the wheel 482, (ii) a radius of the wheel 484 and (iii) a second longitudinal clearance distance L_{C1} between the wheels 482, 484. For example, and without limitation, a shortest one of the longitudinal distances L₁ and L₂ may be determined by how close the respective wheels can be without risking contact with each other in operation. The longest one of the longitudinal distances L₁ and L₂ may then be determined in function of the available space and the pitch of the ground-engaging lugs. The ratio L₂/L₁ may be between 0 and 1.

In some embodiments, the asymmetrical tandem assemblies disclosed herein may be asymmetrical about a lateral center plane of a wheel-carrying structure thereof. Indeed, the developers of the present technology have realized that providing an asymmetry with respect to the lateral center plane (i.e., the plane passing through the pivot axis of the connecting member 428) may also help to reduce structural vibration. FIG. 7B shows a tandem assembly 400′ according to some embodiments of the present technology. The tandem assembly 400′ includes components of the tandem assembly 400 that will be referred to using the same reference numbers for clarity of the present disclosure.

In the tandem assembly 400′, a wheel-carrying structure 402′ is asymmetrical about the lateral center plane 455. A longitudinal distance between the pivot axis of the connecting member 428 and a rotation axis of the wheel 492 is different (e.g. a distance L₂′ is the offset between a longitudinal center of a length of the carrying-arm 426 and the pivot axis of the connecting member 428) from a longitudinal distance between the pivot axis of the connecting member 428 and a rotation axis of the wheel 494. In this illustrative implementation, the longitudinal distance between the pivot axis of the connecting member 428 and a rotation axis of the wheel 492 is equal to L₂/2−L₂′, and the longitudinal distance between the pivot axis of the connecting member 428 and a rotation axis of the wheel 494 is equal to L₂/2+L₂′.

Additionally, a longitudinal distance between the pivot axis of the connecting member 428 and a rotation axis of the wheel 482 is different (e.g. a distance L₁′ is the offset between a longitudinal center of a length of the carrying-arm 416 and the pivot axis of the connecting member 428) from a longitudinal distance between the pivot axis of the connecting member 428 and a rotation axis of the wheel 484. In this illustrative implementation, the longitudinal distance between the pivot axis of the connecting member 428 and a rotation axis of the wheel 482 is equal to L₁/2−L₁′, and the longitudinal distance between the pivot axis of the connecting member 428 and a rotation axis of the wheel 484 is equal to L₁/2+L₁′.

It is contemplated that the longitudinal asymmetry may also be defined in terms of the relative offset between longitudinally spaced wheels and the pivot axis of the connecting member 428. In another embodiment, the distance L₁′ may correspond to the difference between (i) the distance between the pivot axis of the connecting member 428 and the rotation axis of the wheel 484 and (ii) the distance between the pivot axis of the connecting member 428 and the rotation axis of the wheel 482.

It is contemplated that, in some alternative embodiments, only one of the first and second portions 410, 420 may be asymmetrical with respect to the lateral center plane 455.

In some other implementations, the asymmetrical tandem assemblies disclosed herein may be asymmetrical about a lateral center plane of a wheel-carrying structure thereof (as tandem assembly 400′) while being symmetrical about a longitudinal center plane (as tandem assembly 400).

Modifications and improvements to the above-described embodiments of the present invention may become apparent to those skilled in the art. The foregoing description is intended to be exemplary rather than limiting. The scope of the present invention is therefore intended to be limited solely by the appended claims.

1. A tandem wheel assembly for a track system, the tandem wheel assembly comprising:
a wheel-carrying structure pivotably connectable to a frame of the track system, the wheel-carrying structure being configured to pivot relative to the frame about a pivot axis,
the wheel-carrying structure including a first portion extending on one side of the wheel-carrying structure and a second portion extending on the other side of the wheel-carrying structure;
a first wheel and a second wheel rotationally connected to the first portion, the first wheel being longitudinally spaced by a first distance from the second wheel; and
a third wheel and a fourth wheel rotationally connected to the second portion, the third wheel being longitudinally spaced by a second distance from the fourth wheel,
the second distance being different from the first distance.

2. The tandem wheel assembly of claim 1, wherein the tandem wheel assembly is selectively connectable to the frame of the track system.

3. The tandem wheel assembly of claim 2, wherein the tandem wheel assembly is connectable to the frame in one of a first orientation and a second orientation.

4. The tandem wheel assembly of claim 3, wherein in the first orientation, the first portion of the wheel-carrying structure is disposed on a first side of the frame, and in the second orientation, the second portion of the wheel-carrying structure is disposed on the first side of the frame.

5. The tandem wheel assembly of claim 1, wherein at least one of the first distance and the second distance is different from a pitch of traction lugs, and discrete multiples thereof, of an endless track of the track system.

6. The tandem wheel assembly of claim 1, wherein the wheel-carrying structure is symmetrical about a lateral center plane of the wheel-carrying structure.

7. The tandem wheel assembly of claim 1, wherein the wheel-carrying structure is asymmetrical about a lateral center plane of the wheel-carrying structure.

8. The tandem wheel assembly of claim 1, wherein the first distance is a sum of (i) a radius of the first wheel, (ii) a radius of the second wheel and (iii) a longitudinal clearance distance between the first wheel and the second wheel.

9. The tandem wheel assembly of claim 1, wherein the second distance is a sum of (i) a radius of the third wheel, (ii) a radius of the fourth wheel and (iii) a longitudinal clearance distance between the third wheel and the fourth wheel.

10. The tandem wheel assembly of claim 1, wherein:
the first portion comprises a first carrying-arm including:
a first axle onto which the first wheel is mounted, and
a second axle onto which the second wheel is mounted,
and
the second portion comprises a second carrying-arm including:
a third axle onto which the third wheel is mounted, and
a fourth axle onto which the fourth wheel is mounted.

11. A track system comprising:
a frame; and
one or more tandem wheel assembly of claim 1, each of the one or more tandem wheel assembly being pivotably connected to the frame.

12. The track system of claim 11, wherein at least one of the one or more wheel assemblies is further removably connected to the frame.

13. The track system of claim 11, wherein at least one of the one or more tandem wheel assembly is further connected to the frame in at least one of:
a first configuration in which the at least one tandem wheel assembly is connected to the frame such that first and second wheel thereof are disposed inwardly from a longitudinal center plane of the track system and towards the vehicle, and
a second configuration, in which the at least one tandem wheel assembly is connected to the frame such that first and second wheel thereof are disposed outwardly from a longitudinal center plane of the track system and away from the vehicle.

14. The track system of claim 13, wherein:
the one or more tandem wheel assembly comprises a plurality of wheel assemblies, and
one tandem wheel assembly of the plurality of wheel assemblies in the first configuration, and
a second tandem wheel assembly of the plurality of wheel assemblies is in the second configuration,
another tandem wheel assembly of the of the plurality of wheel assemblies is further selectively connected to the frame in a third configuration where the other tandem wheel assembly is connected to the frame such that first and second wheel thereof are disposed inwardly from a longitudinal center plane of the track system and towards the vehicle.

15. A vehicle comprising:
a frame;
at least one track system of claim 11 operatively connected to the frame; and
a powertrain supported by the frame and configured to generate power and transmit said power to the at least one track system.

16. The vehicle of claim 15, wherein:
the at least one track system is a plurality of track system comprising a first track system and a second track system,
the first track system comprises a first tandem wheel assembly, and
the second track system comprises a second tandem wheel assembly.

17. The vehicle of claim 16, wherein the first and second wheel assemblies are in a first configuration, in which the first and second wheel assemblies are connected to the frame such that first and second wheel thereof are disposed inwardly from a longitudinal center plane of the track system and toward the vehicle.

18. The vehicle of claim 16, wherein the first and second wheel assemblies are in a second configuration, in which the first and second wheel assemblies are connected to the frame such that first and second wheel thereof are disposed outwardly from a longitudinal center plane of the track system and away from the vehicle.

19. The vehicle of claim 16, wherein the first and second track systems are one of: front track systems of the vehicle, rear track systems of the vehicle, right track systems of the vehicle, and left track systems of the vehicle.

20. A method for adjusting a traction of a vehicle, the method comprising:
providing a tandem wheel assembly of claim 1, the tandem wheel assembly being removably connected a track system operatively connected to the vehicle in a first configuration such that first and second wheels thereof are disposed inwardly from a longitudinal center plane of the track system and towards the vehicle;
disconnecting the tandem wheel assembly from the track system; and
reconnecting the tandem wheel assembly to the track system in a second configuration such that first and second wheels thereof are disposed outwardly from the longitudinal center plane of the track system and away from the vehicle.
